(19) United States
(12) Patent Application Publication
(10) Pub. No.: US 2007/0118279 A1
(43) Pub. Date: May 24, 2007

(54) System and method for facility search

(75) Inventor: Akiko Kudo, Tokyo (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/581,442

(22) Filed: Oct. 17, 2006

(30) Foreign Application Priority Data
Nov. 21, 2005 (JP) 2005-336389

(51) Int. Cl. G01C 21/00

(52) U.S. Cl. 701/208; 701/201

(57) ABSTRACT

A navigation system for use in a vehicle precludes a certain search area from a scope of a facility search based on a vehicle condition, sensor data, a vehicle travel history or the like for better serving a user by reducing a turnaround time.

### CROSS REFERENCE TO RELATED APPLICATION

This application is based on and claims the benefit of priority of Japanese Patent Application No. 2005-336389 filed on Nov. 21, 2005, the disclosure of which is incorporated herein by reference.

### FIELD OF THE INVENTION

The present invention generally relates to a navigation system for use in a vehicle.

### BACKGROUND OF THE INVENTION

In recent years, a specific type of navigation system provides for a user a route navigation toward a desired facility based on a voice recognition technique. For example, Japanese Patent Application No. JP-A-2004-325181 discloses a navigation system that prioritizes a route navigation toward a parking space in a building when weather conditions detected by various sensors in association with a wiper system, an air conditioner or the like indicate a subject vehicle is traveling in a rain or in high temperature.

Further, Japanese Patent Application No. JP-A-2005-181125 discloses a route navigation method that improves facility search efficiency by conducting a facility search from among facility candidates existing in a preferred range of search direction. That is, the facility search is performed only in a circular area having a predetermined radius around a current position or a specified position, or only in a user-specified direction from a specified position.

Furthermore, Japanese Patent Application No. JP-A-2001-12963 discloses a route navigation method that automatically restricts a facility search area within a predetermined range based on a destination history and stopping time when the user searches for an unknown facility by using a voice input or a manual input of a location name.

However, the facility search method described above includes the facility candidates in the search area that are not necessarily suitable for user's preference, individual variations, and/or vehicle conditions in a time-specific manner because the search is performed on facility data in a database prepared in advance. Therefore, the facility search efficiency is deteriorated and a search speed is compromised. In addition, unwanted facilities included in a search result reduce the user's convenience.

### SUMMARY OF THE INVENTION

In view of the above-described and other problems, the present disclosure provides a navigation system and/or a navigation method that narrows a scope of a facility search for better serving a user by improving search speed and user's convenience in a facility search.

In one aspect of the present disclosure, the navigation system for use in a vehicle having a function of a facility search includes a first search area setting unit for setting a circular facility search area having a predetermined radius centered at a current position of the vehicle when a facility is searched for in a vicinity of the current position of the vehicle on a condition that a map matching function is not in effect and a navigation route is not being provided, a second search area setting unit for setting a directional facility search area toward a traveling direction when a facility is searched for in a vicinity of the current position of the vehicle on a condition that the map matching function is in effect and the navigation route is not being provided, and a third search area setting unit for setting a proximity facility search area along the navigation route when a facility is searched for in a vicinity of the current position of the vehicle on a condition that the navigation route is being provided. In this manner, the navigation system narrows a scope of a facility search based on an operation condition of the vehicle such as a condition of map matching, a navigation route or the like, thereby enabling a search of a desired facility in a reduced turnaround time. For example, a facility search is conducted in a search area that has a circular shape having a predetermined radius centered at a current vehicle position, a directional area having a predetermined distance toward a destination, or a proximity area within a predetermined distance range from a current route, a frequently traveled area based on a travel history, a proximity area within a predetermined distance range from a specified position/area/road or the like. Further, the circular facility search area may be used in the facility search when a facility is searched for in an area that is not in the vicinity of the current vehicle position.

In another aspect of the present disclosure, the navigation system includes a search condition determination unit for determining whether a search area condition of the facility search is set by using one of the first search area setting unit, the second search area setting unit, and the third search area setting unit. In this manner, user's preference of how to determine a scope of the facility search is reflected in the facility search.

In yet another aspect of the present disclosure, the navigation system includes a time input unit for inputting time and date information, and a time-specificity setting unit for imposing time specificity on a search area condition of the facility search based on the time and date information inputted by the time input unit. In this manner, the scope of the facility search is further adapted to user's needs for having a reduced turnaround time by considering a time and a date of the facility search. For example, the facility search in a work hour or in a commuting hour may limit a scope of the facility search to fast food restaurants or the like because a break time allowed in the searched facility is relatively short in the work/commuting hour. On the other hand, the scope of the facility to be searched may be limited to full-service restaurants in a shopping mall or the like when the facility search is performed on holidays, or in a long distance travel.

In still yet another aspect of the present disclosure, the navigation system includes a weather condition input unit for inputting weather condition information, and a weather-specificity setting unit for imposing weather specificity on a search area condition of the facility search based on the weather condition information inputted by the weather condition input unit. In this manner, the scope of the facility search is further adapted to user's needs for having a reduced turnaround time by considering weather conditions at the time of the facility search. For example, the facility search precludes an inconvenient place and situation such as an outdoor parking space on a rainy day, a facility closely located to a school at a going-to-school or coming-back-from-school time. In addition, in a situation such as a holiday shopping for various items in the afternoon of a rainy day, the scope of the facility search includes facilities (i.e., stores) on a not-too-far location in the facility search for a sufficient free indoor parking space.

In still yet another aspect of the present disclosure, the navigation system includes a destination history storage unit for storing a destination history of the vehicle, a route history storage unit for storing a route history of the vehicle, and a historical condition setting unit for imposing specificity of the destination history and the route history on a search area condition of the facility search by referring to the destination history storage unit and the route history storage unit. In this manner, the facility search yields a search result having a higher visiting probability by the user in the reduced turnaround time.

In still yet another aspect of the present disclosure, the navigation system includes a voice recognition unit for recognizing a user's voice, and a control unit for controlling a functional operation according to the users voice recognized by the voice recognition unit. In this manner, the user can interactively narrow the scope of the facility search of the navigation system in a directive manner.

The aspects of the present disclosure described above may be provided as a facility search method implemented by a process in the navigation system or in a similar apparatus. Each of the above described aspects is thereby realized in the process in the navigation system in the same manner.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in a first embodiment of the present disclosure;

FIG. 2 shows a block diagram of software used in the navigation system in FIG. 1;

FIG. 3 shows a facility data table used in a map database in FIG. 2;

FIG. 4 shows an illustration of a facility retrieval range in a case without a map matching and a navigation route in effect in a proximity of a current position, in a case in a proximity of a position different from the current position, or in a similar situation;

FIG. 5 shows an illustration of a facility retrieval range in a case with a map matching without a navigation route in effect in a proximity of a current position, or in a similar situation;

FIG. 6 shows an illustration of a facility retrieval range in a case with a map matching and a navigation route in effect in a proximity of at a current position, or in a similar situation;

FIG. 7 shows an illustration of a facility retrieval range in a case with a history route, or in a similar situation;

FIG. 8 shows a flowchart of a retrieval range setting process in the first embodiment; and

FIG. 9 shows a flowchart of a sensor data acquisition process in FIG. 8.

### DETAILED DESCRIPTION OF THE PREFERRED EMBODIMENTS

The present invention will be described in detail with reference to various embodiments, in which the same reference numerals designate same or similar members.

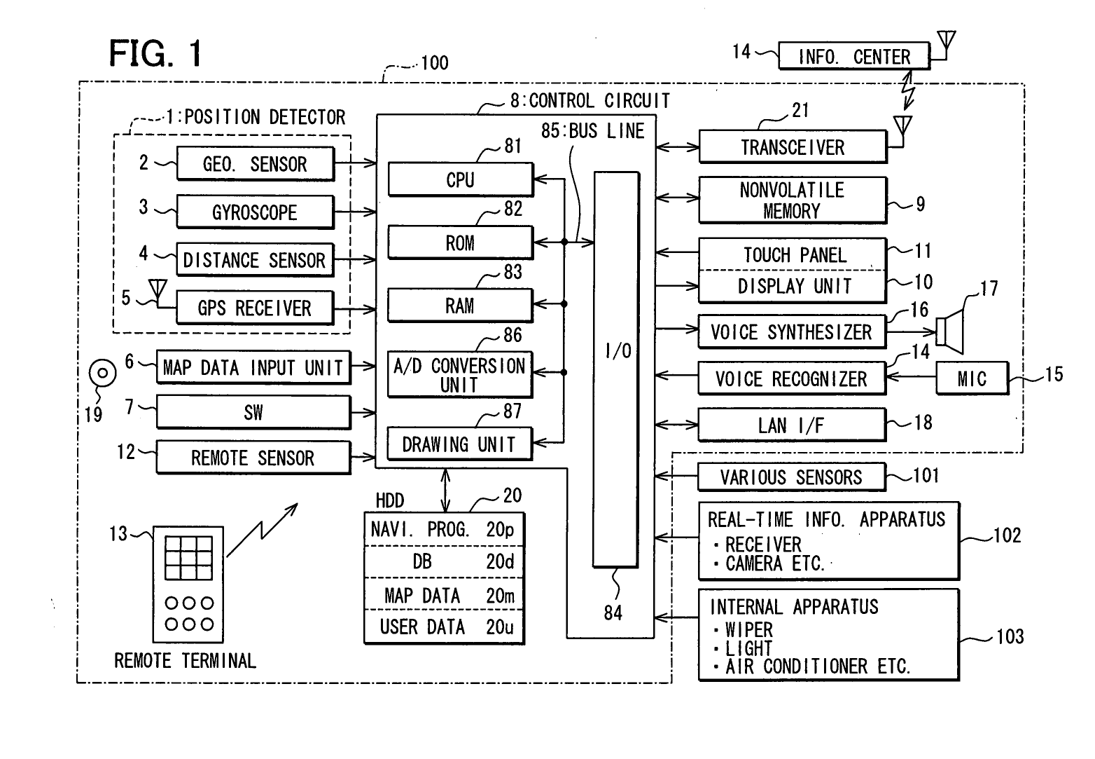

FIG. 1 is a circuit block diagram of a navigation apparatus 100 according to a first embodiment of the present invention. The navigation apparatus 100 according to the first embodiment has a main portion including: a position detector 1; a map data input unit 6; an operation switch group 7; a control circuit 8; a nonvolatile memory 9; a display unit 10; a touch panel 11; a remote control (hereinafter referred to as a remote control) sensor 12; a remote control terminal 13; a voice recognition unit 14; a microphone 15; a voice synthesizing circuit 16; a loudspeaker 17; LAN (Local Area Network) I/F (Interface) 18; a storage medium 19; a hard disk drive (HDD) 20; and a transceiver 21. In FIG. 1, the reference numeral 101 designates various sensors of the vehicle; 102, on-vehicle real-time information apparatuses; 103, internal apparatuses; and 104, an information center.

The position detector 1 includes a well-known geomagnetic sensor 2, a gyroscope 3 that detects a rotational angular velocity of the vehicle, a distance sensor 4 that detects a mileage of the vehicle, and a GPS (Global Positioning System) receiver 5 that detects position of the vehicle based on radio waves from satellites, to calculate absolute coordinates on the earth. These sensors 2, 3, 4, and 5, which respectively have errors of different natures, are compensated by the plural sensors. Depending on precision, part of the sensors described above may be used, and furthermore, a rotation sensor of steering wheel, a wheel sensor of each rolling wheel, e.g., a vehicle speed sensor or the like, may additionally be used.

The input unit 6 is a storage medium reading apparatus that reads data from the storage medium 19 such as CD-ROM (Compact Disk-Read Only Memory), DVD (Digital Versatile Disk), and the like.

The operation switch group 7 is composed of the touch panel 11 integrated with the display unit 10 or a mechanical switch.

The control circuit 8 acquires map image information in the vicinity of absolute coordinates of the position detector 1, and displays map image information and an own vehicle mark in the display screen of the display unit 10. The control circuit 8, constructed as a normal computer, includes a well-known CPU (Central Processing Unit) 81, a ROM (Read Only Memory) 82, a RAM (Random Access Memory) 83, an I/O (Input/Output) 84, an A/D (Analog/Digital) conversion unit 86, a drawing unit 87, and a bus line 85 that connects these components.

The CPU 81 performs control according to a navigation program 20p and data stored in the HDD 20. The CPU 81 controls reading or writing data from or to the HDD 20.

The ROM 82 stores a minimum of programs required to activate the navigation apparatus 100. The ROM 82 may store a program for performing a minimum of required operations of navigation functions when the HDD 20 fails.

The RAM 83 is a memory into which the CPU 81 temporarily loads an instruction and data during execution or processing of a program such as the navigation program 20p.

The A/D conversion part 86 includes a well-known A/D conversion circuit, and for example, converts analog data inputted from the position detector 1 to the control circuit 8 into digital data on which the CPU 81 can operate.

The drawing unit 87 creates display screen data for displaying display data, display color data and the like stored in the HDD 20 on the display unit 10.

The nonvolatile memory 9 is composed of EEPROM (Electrically Erasable & Programmable Read Only Memory) and a rewritable semiconductor memory such as flash memory, and stores information and data necessary for the operation of the navigation apparatus 100. The nonvolatile memory 9 holds storage contents even when accessory switches of the vehicle go off, that is, the navigation apparatus 100 is turned off. Information and data necessary for the operation of the navigation apparatus 100 may be stored in the HDD 10 instead of the nonvolatile memory 9. Furthermore, information and data necessary for the operation of the navigation apparatus 100 may be stored separately in the nonvolatile memory 9 and the HDD 20.

The display unit 10 is composed of a well-known color liquid crystal display unit. It includes a dot matrix LCD (Liquid Crystal Display), and a driver circuit (not shown) for performing LCD display control. The driver circuit employs the active matrix driving system that provides a transistor for each pixel to turn on or off a desired pixel without fail, and makes display based on a display command and display screen data fed from the control circuit 8. As the display unit 10, an organic EL (Electroluminescence) display unit, a plasma display unit or the like may be used.

The touch panel 11 is an input apparatus attached to the display surface of the display unit 10, and sends the coordinates of a user-touched position to the control circuit 8. In the touch panel 11, on the screen of the display unit 10, electrical circuits are wired in X-axis direction and Y-axis direction with a gap called a spacer on a glass board and a transparent film. When a user touches on the film by a pointing member such as a finger, since a wiring of the pressed portion short-circuits and a voltage value changes, it is detected as two-dimensional coordinate value (X,Y). This scheme is the widely used so-called resistance film system. Also, the so-called electrostatic capacity system may be used. Furthermore, in addition to a mechanical switch, a pointing apparatus such as a mouse and the cursor may be used.

The remote control sensor 12 is a receiving unit that receives radio waves from the remote control terminal 13.

The remote control terminal 13 has plural input buttons, and transmits a command or the like corresponding to an operated input button wirelessly to the remote control sensor 12 over radio waves or infrared rays.

The voice recognition unit 14 processes a voice signal inputted from the microphone 15 by voice recognition technology such as the well-known hidden Markov model, makes conversion into a command or the like corresponding to the result, and outputs them to the control circuit 8.

The microphone 15 is a voice input unit that enables user-uttered words to be inputted to the control circuit 8 through the voice recognition unit 14.

The voice synthesizing circuit 16 converts digital voice data stored in the nonvolatile memory 9 or the HDD 20 into an analog voice signal according to a command of the navigation program 20p and outputs the converted analog voice signal. As a method of synthesizing voices, a recoding editing system is available which stores voice waveforms without changing them or stores them after encoding them and combines them as required.

The loudspeaker 17 is connected to the voice synthesizing circuit 16, and generates voice based on an analog voice signal outputted from the voice synthesizing circuit 16.

The LAN I/F 18 is an interface circuit that exchanges of the data with other on-vehicle equipments and sensors via an in-vehicle LAN (not shown in the figure).

The storage medium 19 is a recording medium that stores the navigation program 20p, the database 20d, and the map data 20m and the like. As the storage medium 19, CD-ROM and DVD are generally used because of their data amount. Other media such as a memory card may be used. Data may be downloaded via an external network. Further, for use in the navigation program 20p, the database 20d, the map data 20m, and the user data 20u, additional/update data may be transferred to the HDD 20 from the storage medium 19 by using the map data input unit 6.

The HDD 20 stores the navigation program 20p, so-called map match data for improving the accuracy of position detection, and map data 20m including road data and the like representative of the connections of roads. The map data 20m stores predetermined map image information used for display and road network information including link information and node information and the like. The link information, which is information about sections constituting a respective road, includes position coordinates, distances, travel time, road width, the number of lanes, speed limits, and the like. The node information, which is information which defines intersections (divergence road) and the like, includes position coordinates, the number of right-turn and left-turn lanes, links to destination roads, and the like. Inter-link connection information contains data indicating whether to permit passage or the like. Auxiliary information of route guide and amusement information, and user-specific data can be written to the HDD 20 as user data 20u. These user data 20u may be updated by performing an operation on the switch group 7, the touch panel 11, and the remote control terminal 13, or voice input from the microphone 15. Data and various information necessary for the operation of the navigation apparatus 100 may be stored as the database 20d.

The transceiver 21 is a communication apparatus that transmits and receives data to and from the information center 104.

The various sensors 101 include a vehicle speed sensor, a yaw rate sensor, and the like, and outputs a vehicle speed, a yaw rate, and the like to the control circuit 8. The various sensors 101 also include a timer.

The real-time information apparatuses 102 include a receiver (not shown) that receives traffic information from a traffic information infrastructure such as the Vehicle Information and Communication System (VICS) center (not shown), and cameras (not shown) that photograph the rear and sides of the vehicle, and outputs traffic information, camera pictures, and the like to the control circuit 8.

The internal apparatuses 103 include wipers, lights, an air conditioner, and the like, and inputs weather information such as precipitation, day/night distinction, and high temperatures to the control circuit 8.

The various sensors 101, the real-time information apparatus 102, and the internal apparatus 103 may be connected to the control circuit 8 of the on-vehicle navigation apparatus 100 directly or via the LAN I/F 18.

The information center 104 is an external apparatus that transmits and receives data to and from the on-vehicle navigation apparatus 100 through the transceiver 21. When data on the HDD 20 is updated using wireless data communication, it is accessed through the transceiver 21 from the control circuit 8.

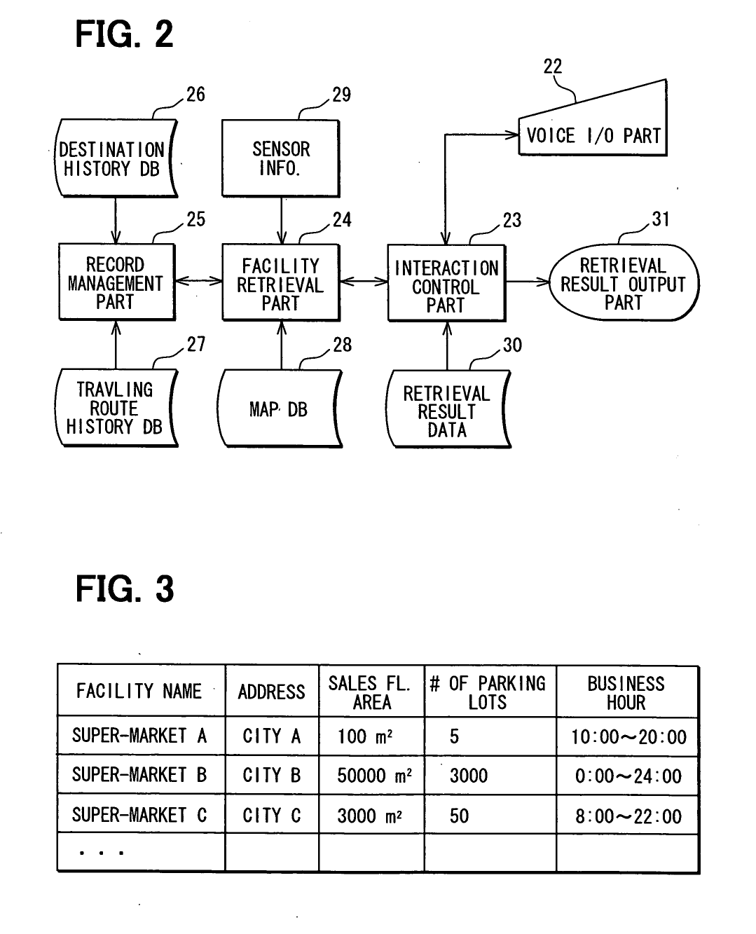

FIG. 2 is a block diagram showing an outline of the software construction of the navigation program 20p. The navigation program 20p includes a voice input/output part 22, an interaction control part 23, a facility retrieval part 24, a record management part 25, a destination history database 26, a traveling route history database 27, a map database 28, sensor information 29, retrieval result data 30, and a retrieval result output part 31. The sensor information 29 is a generic name of information inputted to the control circuit 8 from the various sensors 101, the real-time information apparatuses 102, and the internal apparatuses 103.

FIG. 3 is a facility data table showing an example of facility data included in the map database 28 in FIG. 2. The facility data includes plural records each including a facility name, address, a sales floor area, the number of vehicles to be parked, business hour, and the like.

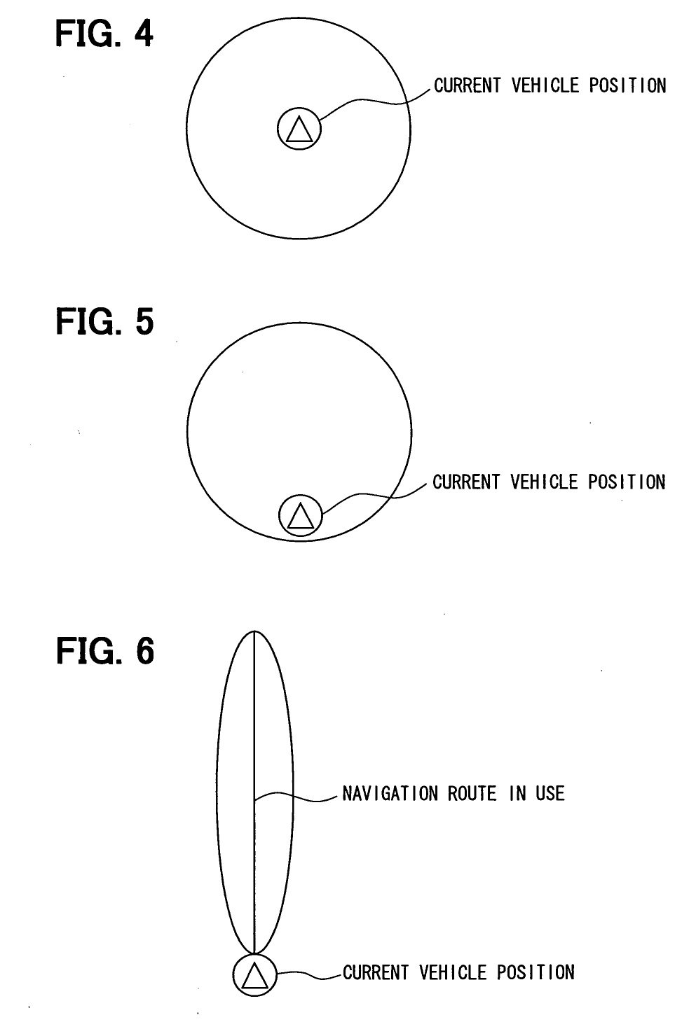

FIG. 4 is an illustration showing the case where the on-vehicle navigation apparatus 100 does not perform map matching during retrieval of facilities around a current position, and there is no navigation route being guided, and a facility retrieval range set when facility retrieval is not performed in the vicinity of the current position. In this example, a circle of a predetermined distance from a current position (specified position) (a circular area having a predetermined radius with the current position at center) is set as a facility retrieval range. The predetermined radius can be changed by the user by performing operations on the operation switch group 7 and the like.

FIG. 5 is an illustration showing a facility retrieval range set in the case where the on-vehicle navigation apparatus 100 performs map matching during retrieval of facilities around a current position, and there is no navigation route being guided. In this example, a predetermined distance area to an advancing direction from a current position (direction to a destination) is set as a facility retrieval range. The predetermined distance can be changed by the user by performing operations on the operation switch group 7 and the like.

FIG. 6 is an illustration showing a facility retrieval range set when there is a navigation route being guided when the on-vehicle navigation apparatus 100 performs facility retrieval in the vicinity of a current position. In this example, a predetermined distance area from the navigation route being guided is set as a facility retrieval range. The predetermined distance can be changed by the user by performing operations on the operation switch group 7 and the like.

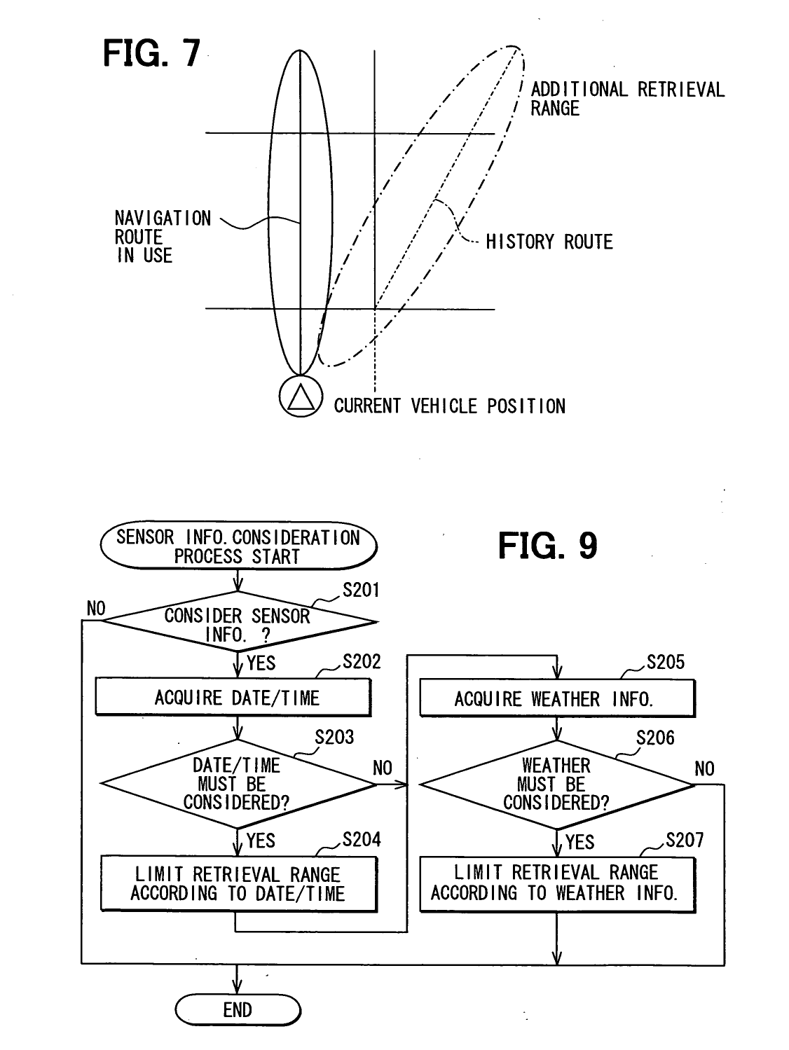

FIG. 7 is an illustration showing a facility retrieval range set by the on-vehicle navigation apparatus 100 when a history route exists or in a similar situation. In this example, for a predetermined distance area from a predetermined distance circle at a current position, a predetermined distance area to an advancing direction, and the navigation route being guided, the predetermined distance area from the history route is set additionally to a facility retrieval range. The predetermined distance can be changed by the user by performing operations on the operation switch group 7 and the like.

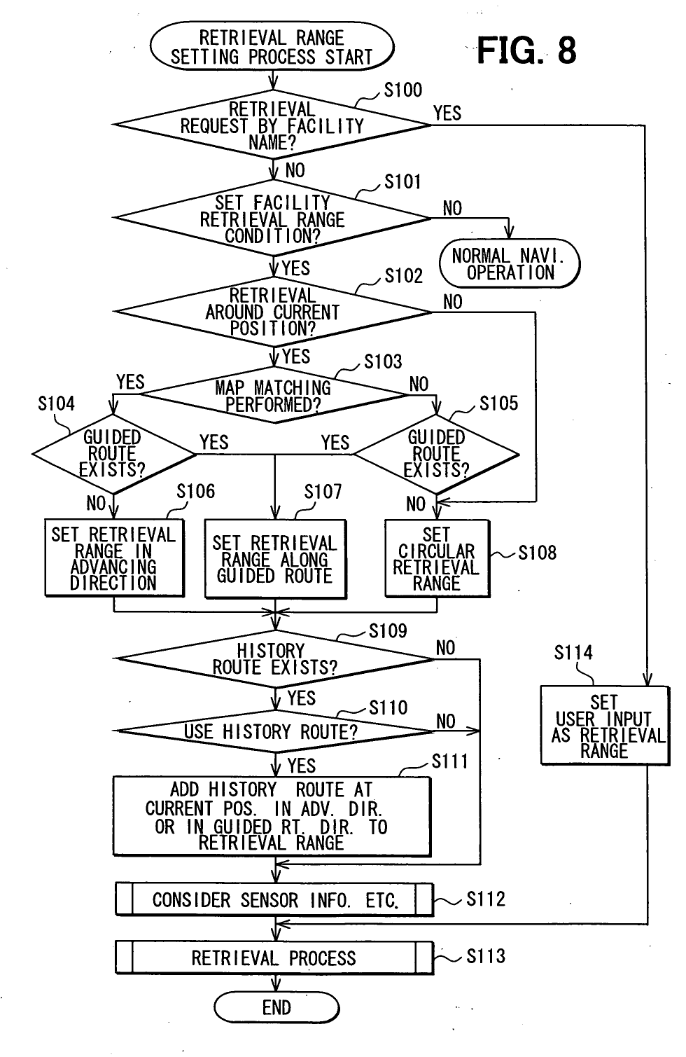

FIG. 8 is a flowchart showing retrieval range setting process in the on-vehicle navigation apparatus 100.

FIG. 9 is a flowchart showing sensor data acquisition process in FIG. 8.

The following describes the operation of the on-vehicle navigation apparatus 100 in the first embodiment thus constructed with reference to FIGS. 1 to 9.

When the user commands the on-vehicle navigation apparatus 100 to perform retrieval of facilities by uttered words, the control circuit 8 inputs the uttered words through the microphone 15 and the voice recognition unit 14 (voice input/output part 22), and the interaction control part 23 determines whether a retrieval request is directly made by a facility name (S100 of FIG. 8).

In the case of a direct retrieval request by a facility name (S100 of FIG. 8: YES), the control circuit 8 sets a facility specified by the user in the range of the retrieval by the facility retrieval part 24 (S114 of FIG. 8), and accesses the map database 28 to perform facility retrieval processing (S113 of FIG. 8).

On the other hand, for other than a direct retrieval request by a facility name (S100 of FIG. 8: NO), the control circuit 8 commands the interaction control part 23 to inquire of the user whether to set conditions in the facility retrieval range, through the voice synthesizing circuit 16 and the loudspeaker 17 (voice input/output part 22) (S101 of FIG. 8).

When the user hears the inquiry uttered from the loudspeaker 17 and sets conditions for the facility retrieval range, the user utters “Set conditions,” and when no conditions are set for the facility retrieval range, the user utters “Set no conditions.”

The control circuit 8 inputs the uttered words through the microphone 15 and the voice recognition unit 14 (voice input/output part 22), and if it is determined by the interaction control part 23 that a reply is made to set no conditions for the facility retrieval range (S101 of FIG. 8: NO), normal navigation operation is performed.

On the other hand, if it is determined by the interaction control part 23 that a reply is made to set conditions for the facility retrieval range (S101 of FIG. 8: YES), the control circuit 8 inquires of the user whether retrieval is to be performed in the vicinity of a current position, through the voice synthesizing circuit 16 and the loudspeaker 17 (voice input/output part 22) (S102 of FIG. 8).

When the user hears the inquiry issued from the loudspeaker 17 and performs retrieval in the vicinity of the current position, the user utters “Is there a bookstore around here?.” When the user does not adhere to retrieval in the vicinity of the current position, the user simply utters “I want to go to a bookstore.”

The control circuit 8 inputs the uttered words through the microphone 15 and the voice recognition unit 14 (voice input/output part 22). If it is determined by the interaction control part 23 that a reply is made to perform no retrieval in the vicinity of the current position (S102 of FIG. 8: NO), the facility retrieval part 24, as shown in FIG. 4, sets a predetermined distance circle centered at the current position (specified position) as a facility retrieval range (S108 of FIG. 8).

If it is determined that retrieval is to be performed in the vicinity of the current position (S102 of FIG. 8: YES), the control circuit 8 determines whether map matching is performed (S103 of FIG. 8).

If it is determined that map matching is being performed (S103 of FIG. 8: YES), the control circuit 8 determines whether there is a navigation route being guided (S104 of FIG. 8).

If there is no route being guided (S104 of FIG. 8: NO), the control circuit 8 sets a circular area to an advancing direction by the facility retrieval part 24 as a facility retrieval range, as shown in FIG. 5 (S106 of FIG. 8).

If there is no navigation route being guided (S104 of FIG. 8: YES), the control circuit 8 sets the vicinity of a navigation route being guided as a facility retrieval range by the facility retrieval part 24, as shown in FIG. 6 (S107 of FIG. 8).

The control circuit 8 refers to the destination history database 26 and the traveling route history database 27 by the history management part 25 to determine whether there is a history route (S109 of FIG. 8). If there is a history route (S109 of FIG. 8: YES), the interaction control part 23 inquires of the user whether to use the history route, through the voice synthesizing circuit 16 and the loudspeaker 17 (voice input/output part 22) (S110 of FIG. 8). For example, the control circuit 8 inquires of the user, “In addition to the road being currently guided, Route 1 taken before runs nearby. Would you like to include Route 1 in a retrieval range?”

When the user hears the inquiry issued from the loudspeaker 17 and uses the history route, for example, the user utters, “Include it in a retrieval range.” When the user does not use the history route, the user utters, for example, “Do not include it in a retrieval range.”

The control circuit 8 inputs the uttered words through the microphone 15 and the voice recognition unit 14 (voice input/output part 22), and if it is determined by the history management part 25 that the history route is used (S110 of FIG. 8: YES), as shown in FIG. 7, for a predetermined distance area from a predetermined distance circle from a current position, a predetermined distance area to an advancing direction, and the navigation route being guided, the predetermined distance area from the history route is set additionally to a facility retrieval range (S111 of FIG. 8). In this case, the control circuit 8 responds to the user, for example, with “Bookstores along Route 23 being currently guided and Route 1 will be targeted for retrieval.”

When there is no history route (S109 of FIG. 8: NO) and the history route is not used (S110 of FIG. 8; NO), the control circuit 8 skips Step S111.

The control circuit 8 starts sensor information consideration processing (S112 of FIG. 8).

In the sensor information consideration processing, the control circuit 8 inquires of the user whether to consider sensor information 29, by the interaction control part 23 through the voice synthesizing circuit 16 and the loudspeaker 17 (voice input/output part 22) (S201 of FIG. 9).

When the user hears the inquiry uttered from the loudspeaker 17 and considers sensor information 29, for example, the user utters, “Consider.” When the user does not consider the sensor information 29, the user utters, “Do not consider.”

The control circuit 8 inputs the uttered words through the microphone 15 and the voice recognition unit 14 (voice input/output part 22), and when it is determined by the interaction control part 23 that a reply is made not to consider sensor information (S201 of FIG. 9: NO), the sensor information consideration processing is immediately terminated.

When it is determined that a reply is made to consider sensor information (S201 of FIG. 9: YES), the control circuit 8 acquires date and time information from the sensor information 29 by the facility retrieval part 24 (S202 of FIG. 9), and inquires of the user whether to consider date and time, through the voice synthesizing circuit 16 and the loudspeaker 17(voice input/output part 22) (S203 of FIG. 9).

The user hears the inquiry uttered from the loudspeaker 17 and must consider a day and a time such as a day of the week (weekday or holiday), and a time zone (in the course of going to work or going home in the case of weekday), the user utters, for example, “Necessary,” and when a reply is made not to consider the sensor information, the user utters, for example, “Unnecessary.”

The control circuit 8 inputs the uttered words through the microphone 15 and the voice recognition unit 14 (voice input/output part 22), and if it is determined by the facility retrieval part 24 that a day and time must be considered (S203 of FIG. 9: YES), limits a facility retrieval range according to the day and time information (S204 of FIG. 9). If a day and a time need not be considered (S203 of FIG. 9: NO), the control circuit 8 skips Step S204.

The control circuit 8 acquires weather information from the sensor information 29 and the like by the facility retrieval part 24 (S205 of the FIG. 9), and inquires of the user whether to consider weather, by the interaction control part 23 through the voice synthesizing circuit 16 and the loudspeaker 17 (voice input/output part 22) (S206 of FIG. 9).

When the user hears the inquiry uttered from the loudspeaker 17 and considers weather such as fine, rain, summer, and winter, for example, the user utters, “Necessary.” When a reply is made not to consider weather, the user utters, “Unnecessary.”

The control circuit 8 inputs the uttered words through the microphone 15 and the voice recognition unit 14 (voice input/output part 22), and if it is determined by the interaction control part 23 that a reply is made to consider weather (S206 of FIG. 9: YES), limits a facility retrieval range according to weather information obtained from the sensor information 29 by the facility retrieval part 24 (S207 of FIG. 9) and terminates the sensor information consideration processing.

If a reply is made not to consider weather (S206 of FIG. 9: NO), the control circuit 8 skips Step S207 and terminates the sensor information consideration processing.

When control returns from the sensor information consideration processing to retrieval range setting processing, the control circuit 8 accesses the map database 28 by the facility retrieval part 24, and performs facility retrieval processing (S113 of FIG. 8). In the retrieval processing, since a facility retrieval range is narrowed down in advance, the control circuit 8 can retrieve a facility suitable for user's situation more rapidly, and retrieval result data 30 is generated. The control circuit 8 outputs, by the interaction control part 23, retrieval result data 30 to the user through the voice synthesizing circuit 16 and the loudspeaker 17 (voice input/output part 22). For example, the control circuit 8 outputs, “There are bookstores A, B, and the like.” to the user. The control circuit 8 displays retrieval result data 30 in the display unit 10 (retrieval result output part 31) by the interaction control part 23.

According to the first embodiment, since a facility retrieval range can be narrowed down in advance according to the operation situation of the vehicle (map matching state and the existence or absence of a navigation route being guided), sensor information, and history information, a facility suitable for user's situation can be retrieved more rapidly.

Although the present disclosure has been fully described in connection with the preferred embodiments thereof with reference to the accompanying drawings, it is to be noted that various changes and modifications will become apparent to those skilled in the art.

For example, the facility search range may be in a different shape from the one described in the above embodiment. That is, the facility search range may take a rectangular shape, a regular/irregular polygonal shape, a fan shape or the like.

Further, sensor information such as a atmospheric pressure, brightness, or the like may be considered in combination with other information for search range determination.

Such changes and modifications are to be understood as being within the scope of the present invention as defined by the appended claims.

What is claimed is:

1. A navigation system for use in a vehicle equipped with a function of a facility search comprising:
a first search area setting unit for setting a circular facility search area having a predetermined radius centered at a current position of the vehicle when a facility is searched for in a vicinity of the current position of the vehicle on a condition that a map matching function is not in effect and a navigation route is not being provided;
a second search area setting unit for setting a directional facility search area toward a traveling direction when a facility is searched for in a vicinity of the current position of the vehicle on a condition that the map matching function is in effect and the navigation route is not being provided; and
a third search area setting unit for setting a proximity facility search area along the navigation route when a facility is searched for in a vicinity of the current position of the vehicle on a condition that the navigation route is being provided.

2. The navigation system as in claim 1,
wherein the first search area setting unit sets the circular facility search area having the predetermined radius centered at the current position when a facility is searched for in an area that is not in the vicinity of the current position of the vehicle.

3. The navigation system as in claim 1 further comprising:
a search condition determination unit for determining whether a search area condition of the facility search is set by using one of the first search area setting unit, the second search area setting unit, and the third search area setting unit.

4. The navigation system as in claim 1 further comprising:
a time input unit for inputting time and date information; and
a time-specificity setting unit for imposing time specificity on a search area condition of the facility search based on the time and date information inputted by the time input unit.

5. The navigation system as in claim 1 further comprising:
a weather condition input unit for inputting weather condition information; and
a weather-specificity setting unit for imposing weather specificity on a search area condition of the facility search based on the weather condition information inputted by the weather condition input unit.

6. The navigation system as in claim 1 further comprising:
a destination history storage unit for storing a destination history of the vehicle;
a route history storage unit for storing a route history of the vehicle; and
a historical condition setting unit for imposing specificity of the destination history and the route history on a search area condition of the facility search by referring to the destination history storage unit and the route history storage unit.

7. The navigation system as in claim 1 further comprising:
a voice recognition unit for recognizing a user's voice; and
a control unit for controlling a functional operation according to the user's voice recognized by the voice recognition unit.

8. A method of a facility search in a navigation system for use in a vehicle comprising:
setting a circular facility search area having a predetermined radius centered at a current position of the vehicle when a facility is searched for in a vicinity of the current position of the vehicle on a condition that a map matching function is not in effect and a navigation route is not being provided;
setting a directional facility search area toward a traveling direction when a facility is searched for in a vicinity of the current position of the vehicle on a condition that the map matching function is in effect and the navigation route is not being provided; and
setting a proximity facility search area along the navigation route when a facility is searched for in a vicinity of the current position of the vehicle on a condition that the navigation route is being provided.

9. The method as in claim 8,
wherein the circular facility search area having the predetermined radius centered at the current position is used for the facility search when a facility is searched for in an area that is not in the vicinity of the current position of the vehicle.

10. The method as in claim 8 further comprising:
determining whether a search area condition of the facility search is one of the circular facility search area, the directional facility search area, and the proximity facility search area.

11. The method as in claim 8 further comprising:
acquiring time and date information; and
imposing time specificity on a search area condition of the facility search based on the time and date information.

12. The method as in claim 8 further comprising:
acquiring weather condition information; and
imposing weather specificity on a search area condition of the facility search based on the weather condition information.

13. The method as in claim 8 further comprising:
storing a destination history of the vehicle in a destination data storage;
storing a route history of the vehicle in a route data storage; and
imposing specificity of the destination history and the route history on a search area condition of the facility search by referring to the destination history in the destination data storage and the route data storage.

14. The method as in claim 8 further comprising:
recognizing a user's voice; and
controlling a functional operation according to the recognized user's voice.
